(19) United States
(12) Patent Application Publication
(10) Pub. No.: US 2002/0174189 A1
(43) Pub. Date: Nov. 21, 2002

(54) Apparatus and methods for intelligently caching applications and data on a mobile device

(76) Inventor: Luosheng Peng, San Jose, CA (US)

Correspondence Address: Steven Artim, Chief Executive Officer, DoOnGo Technologies Inc, 2065 Martin Ave., Suite 108, Santa Clara, CA, 95050, US

(21) Appl. No.: 09/840,736

(22) Filed: Apr. 23, 2001

(51) Int. Cl. G06F 15/16

(52) U.S. Cl. 709/217

(57) ABSTRACT

An exemplary method for intelligently caching application or data on a mobile device comprises the steps of receiving a request to execute or access a set of files, the set of files including an application or data, downloading the set of files from a remote server or a gateway if the set of files is not pre-loaded or cached, calculating a cache benefit index for the set of files, determining available free space in a local file system, caching the set of files in the local file system in accordance with the cache benefit index, saving corresponding meta information in a database, recording the request in the database, and returning the location of the requested application in the local file system.

### FIELD OF THE INVENTION

This invention relates to apparatus and methods for intelligently caching applications and data. In particular, this invention relates to apparatus and methods for intelligently caching applications and data on a mobile device.

### BACKGROUND OF THE INVENTION

Generally, wireless/mobile devices include a user interface, such as a micro-browser, pre-installed on a wireless/mobile device and a set of fixed applications and hierarchical menus for Internet access. Using the micro-browser, a user browses the Internet using the fixed menus or by manually entering specific uniform resource locators (URLs).

Most wireless/mobile devices have inadequate processing capability for retrieving information, such as applications or data, and very limited memory space for caching such information. Thus, downloading applications or data from the Internet onto a mobile device may be very slow and sometimes unsuccessful. One possible solution to circumvent the need to repeatedly downloading from the Internet is to cache applications and data on the mobile device. Because mobile devices have very limited memory space, an intelligent caching of the most likely to be called applications or data is necessary to optimize this solution.

Thus, it is desirable to provide apparatus and methods for intelligently caching applications and data on a mobile device.

### SUMMARY OF THE INVENTION

An exemplary method for intelligently caching application or data on a mobile device comprises the steps of receiving a request to execute or access a set of files, the set of files including an application or data, downloading the set of files from a remote server or a gateway if the set of files is not pre-loaded or cached, calculating a cache benefit index for the set of files, determining available free space in a local file system, caching the set of files in the local file system in accordance with the cache benefit index and the available free space, saving corresponding meta information in a database, recording the request in the database, and returning the location of the requested application in the local file system. In an exemplary embodiment, the downloading step further comprises the steps of opening a communication session with the remote server or the gateway, sending a download request to the remote server or the gateway, receiving a response, the response including the set of files, and closing the communication session with the remote server or the gateway.

In one embodiment, the exemplary method further comprises the step of searching a storage table in the database for a record that matches the set of files to determine whether the set of files is pre-loaded or cached. In another embodiment, the exemplary method further comprises the steps of parsing the response to find a broadcast message, accessing and updating a storage table in the mobile database in accordance with the broadcast message, and sending a broadcast response to the remote server or the gateway. In an exemplary embodiment, the accessing and updating steps includes the step of marking at least one set of files as out-of-date in accordance with the broadcast message.

In another embodiment, the step of determining available free space in a local file system includes the steps of comparing the cache benefit index to other cache benefit indices associated with applications or data already cached in the local file system (cached applications or data), determining if enough space in the local file system can be generated by removing some or all of the cached applications or data whose cache benefit indices are less than the cache benefit index, and removing some or all of the cached applications or data whose cache benefit indices are less than the cache benefit index if enough space in the local file system can be generated. In an exemplary embodiment, the caching step includes step caching the set of files in the local file system if the cache benefit index is greater than a threshold value and the available free space indicates that there is enough space in the local file system to cache the set of files. In another exemplary embodiment, a current total available cache space is calculated after the set of files is cached into the local file system.

In yet another embodiment, the exemplary method further comprises the step of initiating and maintaining sub-transactions during the downloading, the sub-transactions including application cache space management, data cache space management, and communication transactions.

An exemplary computer program product for intelligently caching application or data on a mobile device comprises logic code for receiving a request to execute or access a set of files, the set of files including an application or data, logic code for downloading the set of files from a remote server or a gateway if the set of files is not pre-loaded or cached, logic code for calculating a cache benefit index for the set of files, logic code for determining available free space in a local file system, logic code for caching the set of files in the local file system in accordance with the cache benefit index and the available free space, logic code for saving corresponding meta information in a database, logic code for recording the request in the database, and logic code for returning the location of the requested application in the local file system. In an exemplary embodiment, the logic code for downloading further comprises logic code for opening a communication session with the remote server or the gateway, logic code for sending a download request to the remote server or the gateway, logic code for receiving a response, the response including the set of files, and logic code for closing the communication session with the remote server or the gateway.

In one embodiment, the exemplary computer program product further comprises logic code for searching a storage table in the database for a record that matches the set of files to determine whether the set of files is pre-loaded or cached.

In another embodiment, the exemplary computer program product further comprises logic code for parsing the response to find a broadcast message, logic code for accessing and updating a storage table in the mobile database in accordance with the broadcast message, and logic code for sending a broadcast response to the remote server or the gateway. In an exemplary embodiment, the logic code for accessing and updating includes logic code for marking at least one set of files as out-of-date in accordance with the broadcast message.

In yet another embodiment, the logic code for determining available free space in a local file system includes logic code for comparing the cache benefit index to other cache benefit indices associated with cached applications or data, logic code for determining if enough space in the local file system can be generated by removing some or all of the cached applications or data whose cache benefit indices are less than the cache benefit index, and logic code for removing some or all the cached applications or data whose cache benefit indices are less than the cache benefit index if enough space in the local file system can be generated. In an exemplary embodiment, the logic code for caching includes caching the set of files in the local file system if the cache benefit index is greater than a threshold value and the available free space indicates that there is enough space in the local file system to cache the set of files. In another exemplary embodiment, the computer program product further comprises logic code for calculating a current total available cache space after the set of files is cached into the local file system.

In yet another embodiment, the exemplary computer program product further comprises logic code for initiating and maintaining sub-transactions during the downloading, the sub-transactions including application cache space management, data cache space management, and communication transactions.

### BRIEF DESCRIPTION OF THE DRAWINGS

FIG. 1 schematically illustrates an exemplary prior art system.

FIG. 2 schematically illustrates an exemplary mobile device in accordance with an embodiment of the invention.

FIG. 3 schematically illustrates an exemplary two level transaction support process in accordance with an embodiment of the invention.

FIG. 4 illustrates an exemplary process in accordance with an embodiment of the invention.

FIG. 5 illustrates an exemplary application identification table in accordance with an embodiment of the invention.

FIG. 6 illustrates an exemplary data identification table in accordance with an embodiment of the invention.

FIG. 7 illustrates an exemplary compression methods table in accordance with an embodiment of the invention.

FIG. 8 illustrates an exemplary application download table in accordance with an embodiment of the invention.

FIG. 9 illustrates an exemplary data download table in accordance with an embodiment of the invention.

FIG. 10 illustrates an exemplary application storage table in accordance with an embodiment of the invention.

FIG. 11 illustrates an exemplary data storage table in accordance with an embodiment of the invention.

FIG. 12 illustrates an exemplary application execution table in accordance with an embodiment of the invention.

FIG. 13 illustrates an exemplary data access table in accordance with an embodiment of the invention.

FIG. 14 illustrates an exemplary application cache change table in accordance with an embodiment of the invention.

FIG. 15 illustrates an exemplary data cache change table in accordance with an embodiment of the invention.

FIG. 16 illustrates an exemplary configuration table in accordance with an embodiment of the invention.

FIG. 17 illustrates another exemplary process in accordance with an embodiment of the invention.

FIG. 18 illustrates another exemplary process in accordance with an embodiment of the invention.

FIG. 19 illustrates another exemplary process in accordance with an embodiment of the invention.

FIG. 20 schematically illustrates exemplary smart connectivity protocol state machines in accordance with an embodiment of the invention.

### DETAILED DESCRIPTION OF THE INVENTION

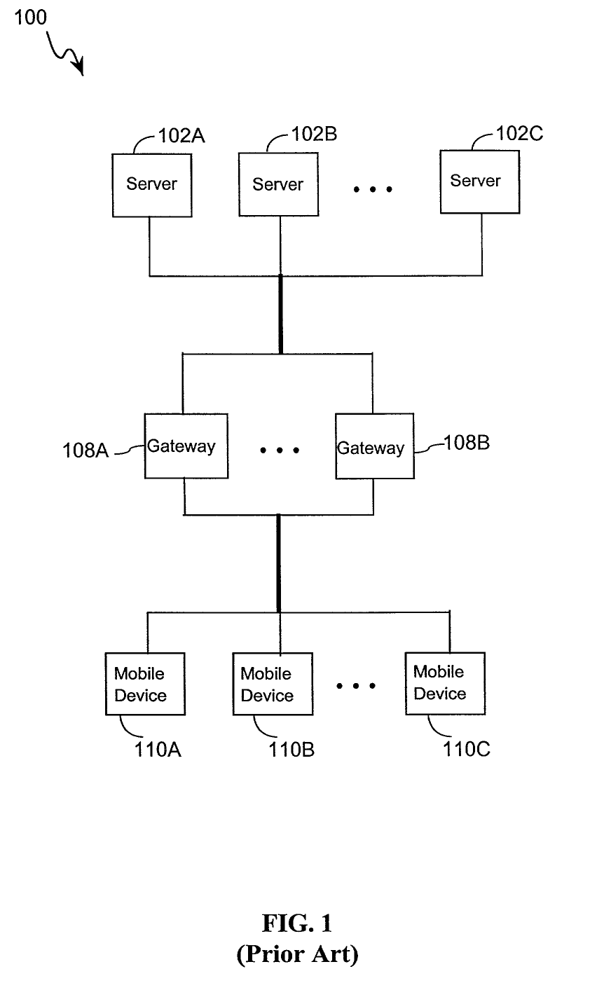

FIG. 1 illustrates an exemplary prior art system 100. The system 100 includes multiple servers connected to multiple gateways that service multiple mobile devices. For ease of explanation, only a representative number of servers, gateways, and mobile devices are shown in FIG. 1. The system 100 includes servers 102A-102C, gateways 108A-108B, and mobile devices 110A-110C.

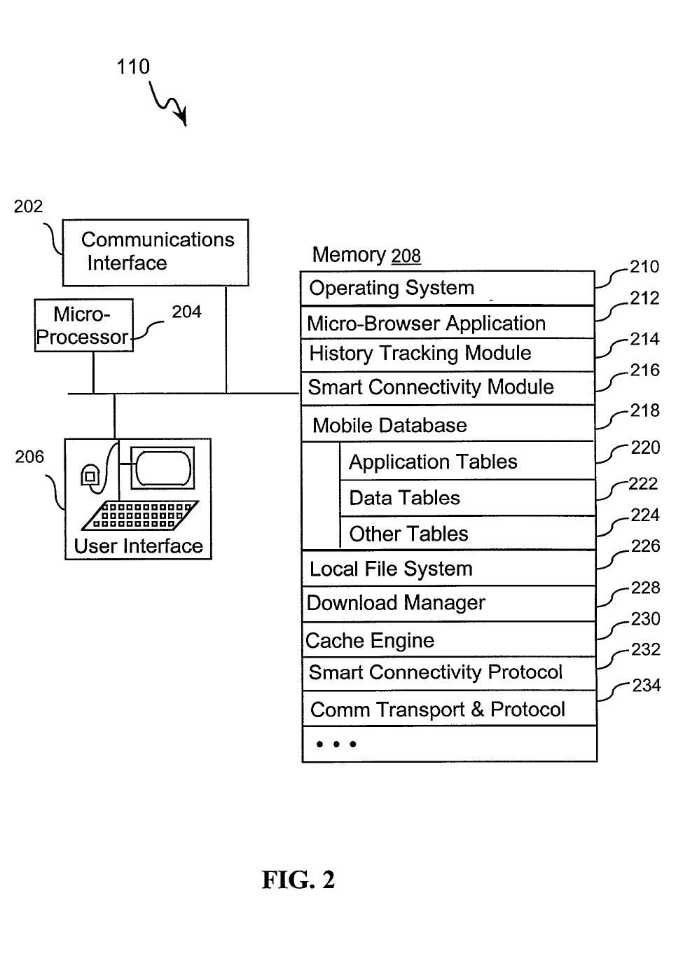

FIG. 2 schematically illustrates an exemplary mobile device 110 in accordance with an embodiment of the invention. The mobile device 110 includes a communications interface 202 for communicating with a network, a microprocessor 204, a user interface 206, and a memory 208. In an exemplary embodiment, the user interface includes a user input device (e.g., keyboard) and an output device (e.g., screen). The memory 208 includes an operating system 210, a micro-browser application 212, a user operation history tracking module 214 for tracking user operation history, a smart connectivity module 216, a mobile database 218, a local file system 226, a download manager 228, a cache engine 230, a smart connectivity protocol 232, and a communications transport protocol module 234 for adapting to different transport protocols in the network. In an exemplary embodiment, the mobile database 218 includes a set of application tables 220, a set of data tables 222, and a set of other tables 224 for tracking user operation and cache storage information.

In an exemplary embodiment, the micro-browser application 212 provides a graphical user interface to a user. In one embodiment, a list of applications may be presented via the micro-browser application 212 to the user for receiving user selection. Each item in the list of applications includes a uniform resource locator (URL) and a brief description of the application. For example, the brief description includes a function description, product promotion, or URLs to other related web pages. In an exemplary embodiment, the user can select an application by browsing the list and highlighting the application or by entering an application number. When an application is selected, it is either loaded from the local file system 226, from the gateway 108, or from a remote server 102. The application selection information is tracked by the user operation history tracking module 214 and recorded in the application tables 220 and data tables 222 in the mobile database 218.

The smart connectivity module 216 determines whether an application or data requested for execution or access is already stored in the local file system 226 and sends a request to the gateway 108 or a remote server 102 via the download manager 228 to download the requested application or data if it is not stored in the local file system 226. The smart connectivity module 216 calls the cache engine 230 to intelligently determine (based on a calculated cache benefit index) whether a downloaded application/data should be cached, and if so, whether there is enough space to do so. Additionally, the smart connectivity module 216 maintains meta information (i.e., synchronization version, app/data identification, etc.) for all cached application/data in the mobile database 218 in one or more of the tables 220-224.

When an application/data is downloaded, all files belonging to that application/data, including the executable files, configuration files, property files, online help files, etc., are downloaded as a bundle. Similarly, when an application/data is cached, all files belonging to that application/data are cached in the local file system 226.

In an exemplary embodiment, if the gateway 108 and the server 102 are compatible (3i) gateway and (3i) server, respectively, communications between the mobile device 110 and the gateway 108 or the server 102 are based on the smart connectivity protocol 232 that is stacked on top of the communication transport and protocol 234 (e.g., wireless application protocol (WAP), TCP/IP, HTTP, infra-red data association (IrDA), or Bluetooth). If the gateway 108 and the server 102 are not compatible (non-3i), then communications between the mobile device 110 and such gateway and server are based only on the communication transport and protocol 234. Additional description relating to the 3i gateway and the 3i server is disclosed in co-pending applications entitled “Apparatus and Methods for Intelligently Caching Applications and Data on a Gateway,” bearing Ser. No. ______, filed on ______ and entitled “Apparatus and Methods for Managing Caches on a Gateway,” bearing Ser. No. ______, filed on ______. These applications are hereby incorporated by reference for all purposes.

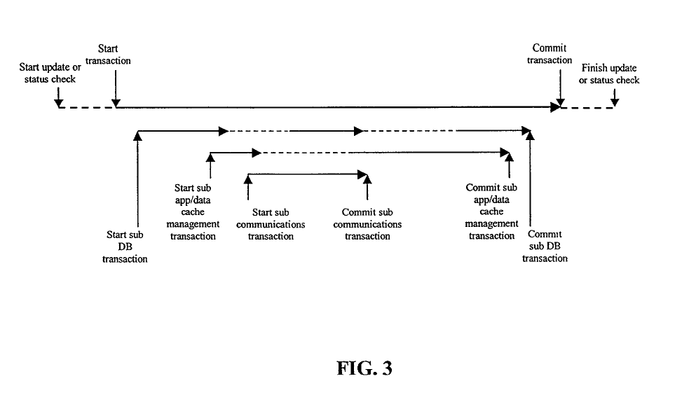

FIG. 3 illustrates an exemplary transaction and sub-transaction management in accordance with an embodiment of the invention. During each application/data downloading or application/data caching, the smart connectivity module 216 maintains the consistency and integrity among database operations and application/data cache space management. A transaction corresponding to an application/data update or status check is created after the smart connectivity module 216 initiates the update or status check request on the mobile device 110. The transaction is committed when the smart connectivity module 216 succeeds in the update or status check processes; otherwise, if the smart connectivity module 216 fails in the processes, the transaction is rolled back to its original state. In an exemplary embodiment, during a transaction processing, the smart connectivity module 216 may also create several sub-transactions within the transaction for various database operations. For example, the sub-transactions include an application or data cache space management transaction and communication transactions with the gateway 108 or a remote server 102. Sub-transactions become fully committed when the initial transaction becomes committed.

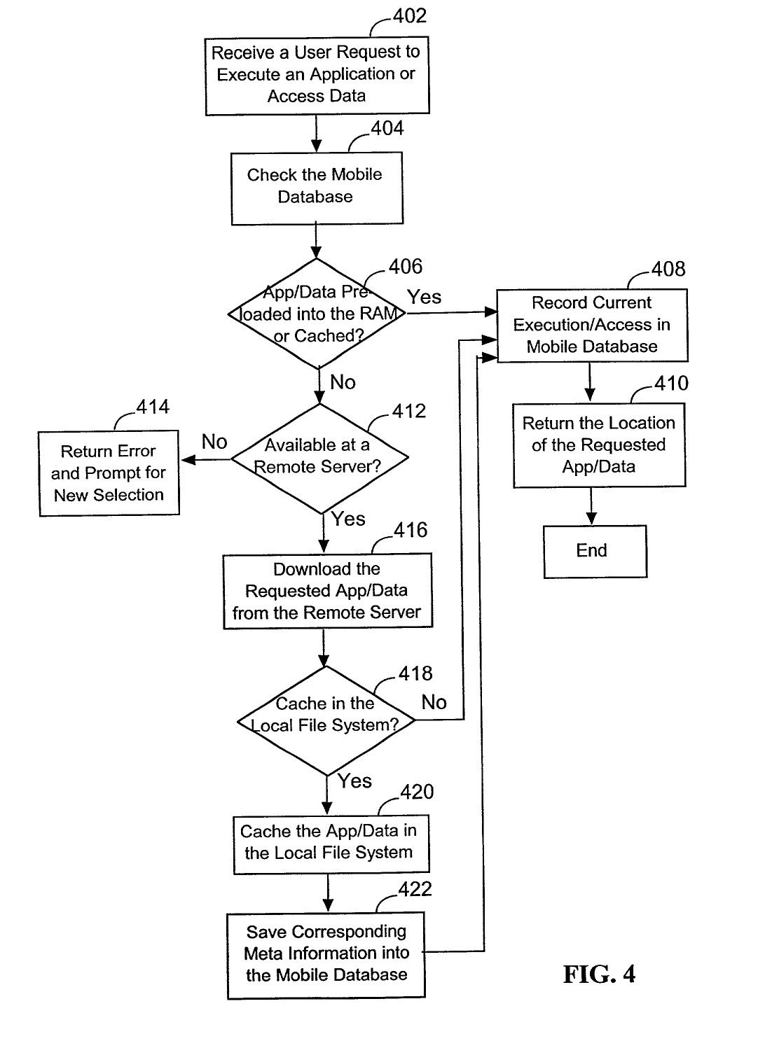

FIG. 4 illustrates an exemplary process in accordance with an embodiment of the invention. At step 402, a user request to execute an application or to access data is received via the micro-browser application 212. In an exemplary embodiment, the smart connectivity module 216 is called to process the request. The smart connectivity module 216 checks the mobile database 218 to determine whether the requested application or data has been pre-loaded or cached in the local file system 226 (step 404). If the requested application or data was pre-loaded or cached (step 406), the current execution/access request is recorded in the mobile database 218 (step 408) and the location of the requested application or data is returned (step 410). Referring back to step 406, if the requested application or data was not pre-loaded or cached, whether it is available at the gateway 108 or the server 102 is determined (step 412). If not, an error code is returned and the user may be prompted to make another selection (step 414). If the requested application or data is available at the gateway 108 or the remote server 102, it is downloaded by the smart connectivity module 216 via the download manager 228 (step 416). After the application or data is downloaded, whether it should be cached in the local file system 226 is determined (step 418). In an exemplary embodiment, the smart connectivity module 216 calls the cache engine 230 to determine whether to cache a downloaded application or data. If not, the process continues at step 408. Referring back to step 418, if the downloaded application or data should be cached in the local file system 226, it is cached (step 420). Next, the smart connectivity module 216 saves any corresponding meta information into the mobile database (step 422) and the process continues at step 408.

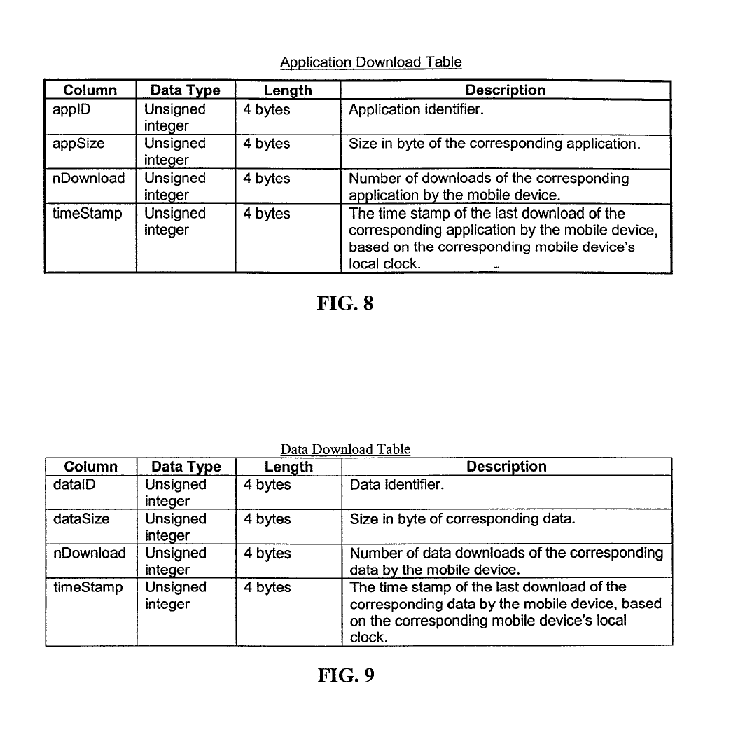

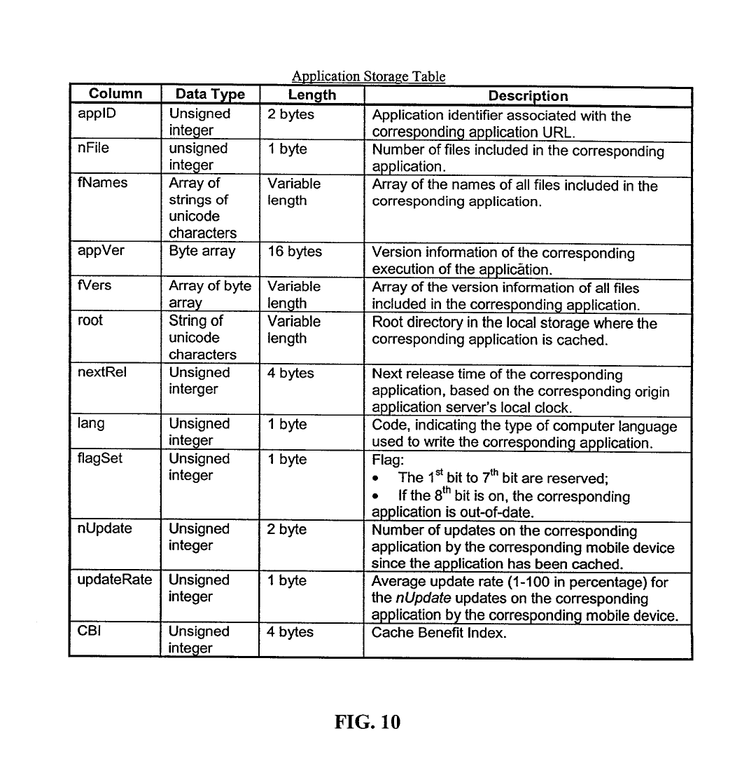

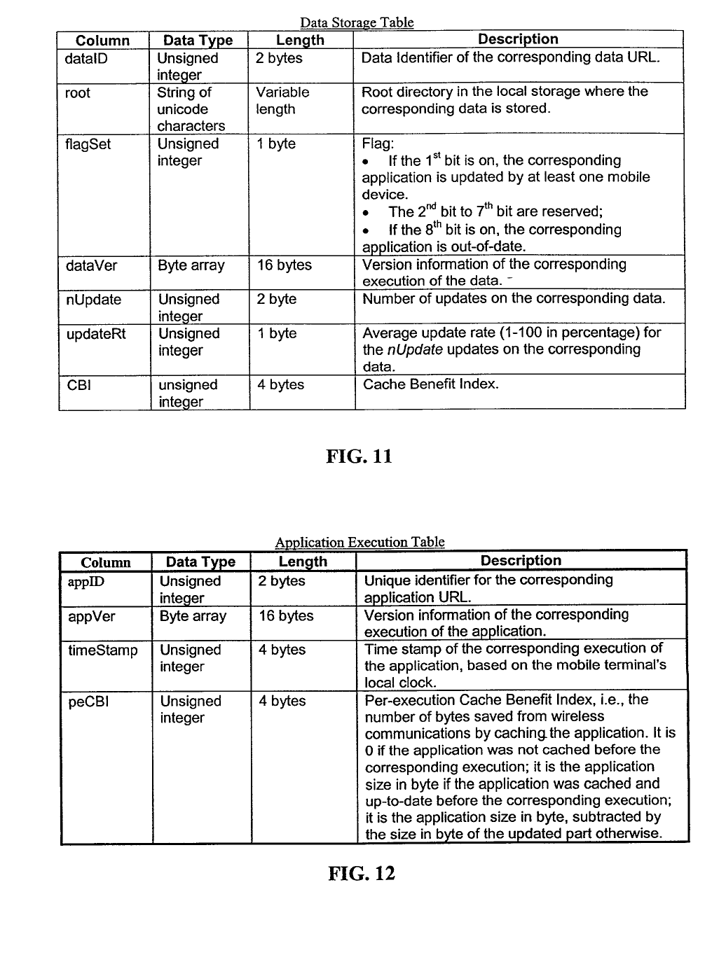

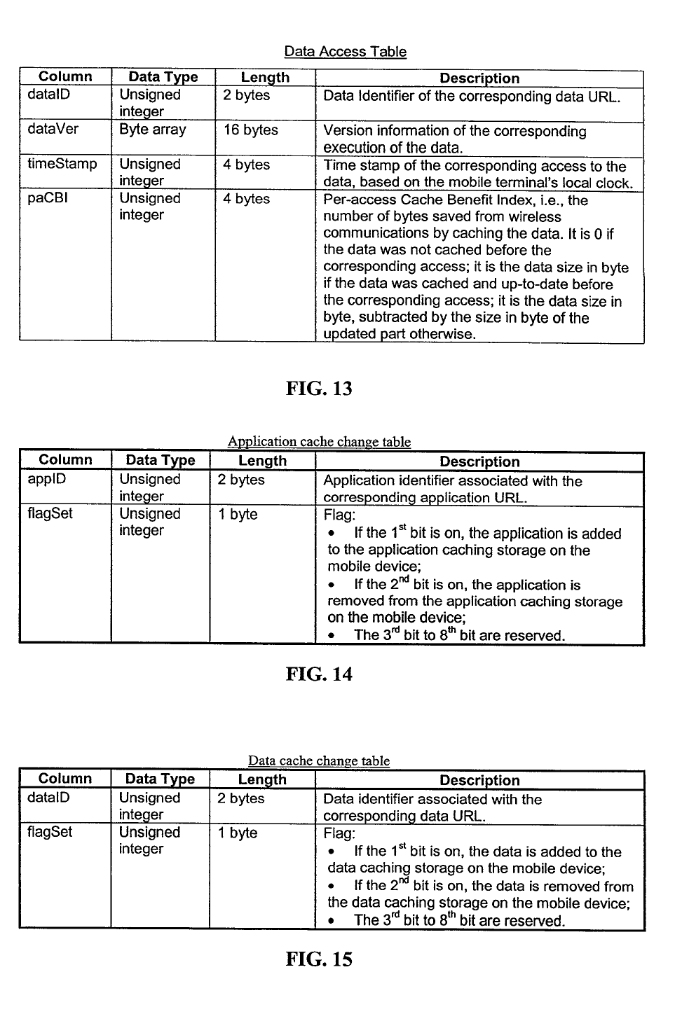

In an exemplary embodiment, the mobile database 218 includes a number of tables 220-224. Each table is designed to maintain a type of logical information. The smart connectivity module 216 updates the mobile database 218 and the local file system 226 in accordance with each operation performed. For example, if a requested application or data is already pre-loaded or cached, the smart connectivity module 216 updates the corresponding application execution table (see FIG. 12 below) or data access table (see FIG. 13 below). If a requested application or data is not already cached, the smart connectivity module 216 calls the download manager 228 to download the application or data. Next, the smart connectivity module 216 updates the application download table (see FIG. 8 below) or the data download table (see FIG. 9 below). The smart connectivity module 216 then calls the cache engine 230 to determine whether to cache the downloaded application. If so, the application or data is cached, and the smart connectivity module 216 updates the application storage table (see FIG. 10 below) or the data storage table (see FIG. 11 below) and the application cache change table (see FIG. 14 below) or the data cache change table (see FIG. 15 below).

The mobile database 218 is managed in the mobile device 110 by either a third-party (commercially available) database management system or a built-in micro database management system in the mobile operation system 210. In an exemplary embodiment, twelve tables are maintained in the mobile database 218. Exemplary tables are illustrated in FIGS. 5-16 below.

FIG. 5 illustrates an exemplary application identification table. The purpose of this table is to associate each application uniform resource locator (URL) to a unique identifier.

FIG. 6 illustrates an exemplary data identification table. The purpose of this table is to associate each data URL to a unique identifier.

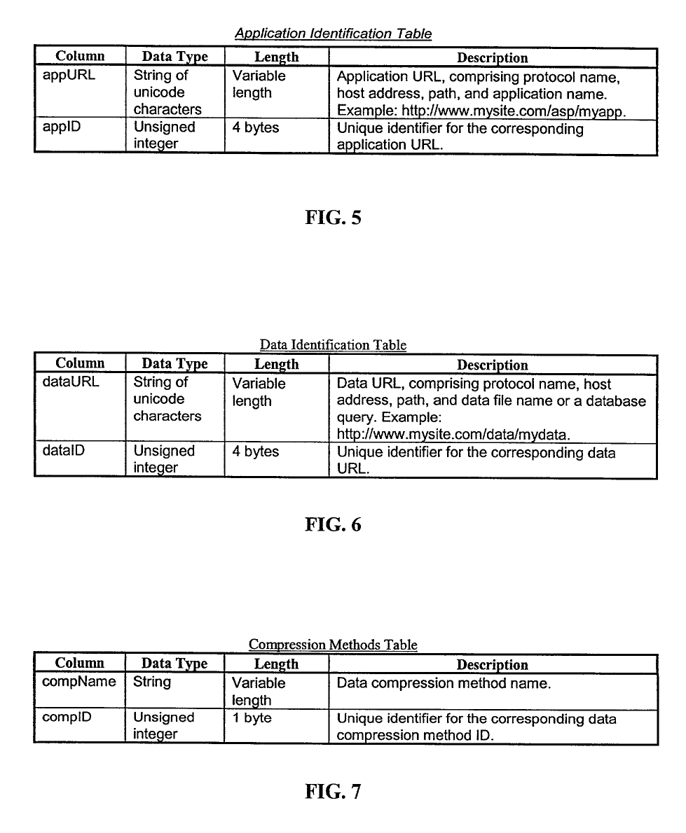

FIG. 7 illustrates an exemplary compression methods table. The purpose of this table is to associate each data compression method name to a unique identifier.

FIG. 8 illustrates an exemplary application download table. The purpose of this table is to track the download histories of all applications downloaded by the mobile device 110.

FIG. 9 illustrates an exemplary data download table. The purpose of this table is to track the download histories of all data downloaded by the mobile device 110.

FIG. 10 illustrates an exemplary application storage table. The purpose of this table is to maintain the meta information associated with all cached applications in the mobile device 110.

FIG. 11 illustrates an exemplary data storage table. The purpose of this table is to maintain the meta information associated with all cached data in the mobile device 110.

FIG. 12 illustrates an exemplary application execution table. The purpose of this table is to track the execution histories of all downloaded applications at the mobile device 110.

FIG. 13 illustrates an exemplary data access table. The purpose of this table is to track the access histories of all downloaded data at the mobile device 110.

FIG. 14 illustrates an exemplary application cache change table. The purpose of this table is to maintain a list of application URLs that have been swapped in or out of the local file system 226 until the information is transferred to the gateway 108.

FIG. 15 illustrates an exemplary data cache change table. The purpose of this table is to maintain a list of data URLs that have been swapped in or out of the local file system 226 until the information is transferred to the gateway 108.

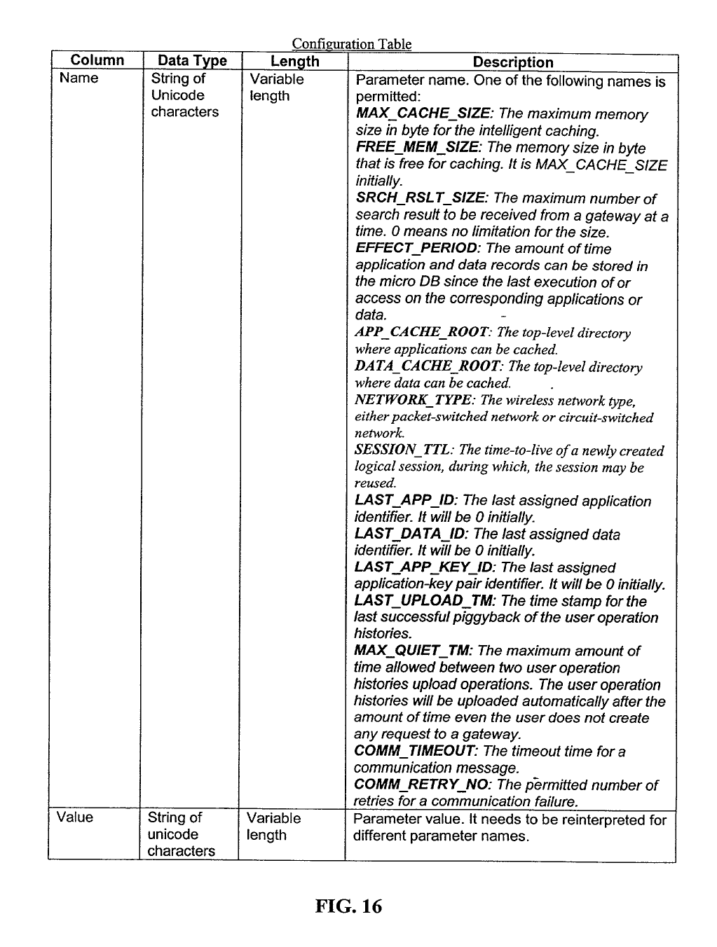

FIG. 16 illustrates an exemplary configuration table. The purpose of this table is to set and maintain a set of configuration parameters that control the behavior of the mobile device 110.

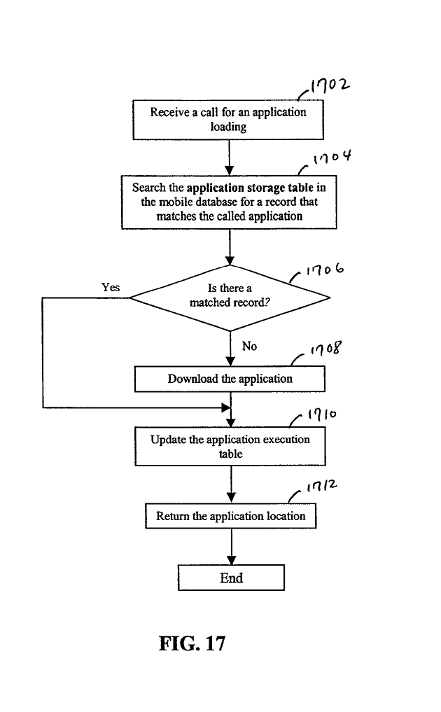

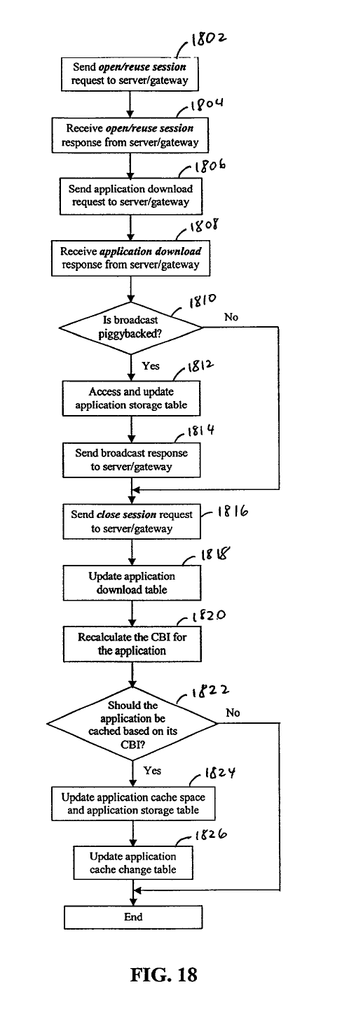

FIG. 17 illustrates an exemplary application loading process in accordance with an embodiment of the invention. At step 1702, a call for an application loading is received. Next, the application storage table (see FIG. 10) is searched for a record that matches the called application (step 1704). If there is a matching record (step 1706), the application execution table (see FIG. 12) is updated (step 1710). In an exemplary embodiment, if the called application is already pre-loaded or cached in the local file system 226, there is a match in the application execution table. Referring back to step 1706, if there is no matching record, the called application is downloaded from the gateway 108 or a remote server 102 (step 1708) and the application execution table is updated (step 1710). An exemplary process to download an application is described in FIG. 18 below. Next, the application location is returned for loading (step 1712).

FIG. 18 illustrates an exemplary download process in accordance with an embodiment of the invention. At step 1802, a request to open or reuse a communications session is sent to the gateway 108 or a remote server 102. Next, a response is received from the gateway 108 or the remote server 102 (step 1804). An application download request is sent to the gateway 108 or the remote server 102 (step 1806). A response to the download request is received from the gateway 108 or the remote server 102 (step 1808). In an exemplary embodiment, the response includes the requested application. The response is parsed to determine whether a broadcast is piggybacked (step 1810). If so, the application storage table (see FIG. 10) is accessed and updated (step 1812). In an exemplary embodiment, a broadcast message includes an application URL and an application version for each of one or more applications. The application storage table is searched for the appVer and flagSet fields of each record that is associated with an application URL component in the broadcast message. The appVer of a matching record and an application version component in the broadcast message are compared. If the versions are different, then set a corresponding flagSet field to indicate that the associated application is out-of-date. This process repeats for all applications in the broadcast message. Next, a broadcast response is sent back to the gateway 108 or the remote server 102 (step 1814) and the process continues at step 1816. Referring back to step 1810, if no broadcast information is piggybacked, the process continues at step 1816.

At step 1816, a close session request is sent to the gateway 108 or the remote server 102 and the communication is disconnected. The application download table (see FIG. 8) is updated (step 1818). The CBI for the downloaded application is calculated (step 1820). Whether the downloaded application should be cached is determined based on the calculated CBI and available free space in the local file system (step 1822). If not, the process ends. If the downloaded application is to be cached, the local file system 226 is updated with the downloaded application and the application storage table (see FIG. 10) is also updated (step 1824). In an exemplary embodiment, a new record corresponding to the downloaded application is created and inserted into the application storage table. In an exemplary embodiment, some or all cached applications may have to be removed to create enough space in the local file system 226 for storing the downloaded application. In such a case, the removed application(s)'s corresponding records are removed from the application storage table. Next, the application cache change table (see FIG. 14) is updated (step 1826). In an exemplary embodiment, if one or more records were removed from the application storage table, new records associated with the removed records are created and added to the application cache change table.

Although FIGS. 17-18 only describe exemplary processes to load and download an application, a person skilled in the art would recognize that these processes similarly apply to load or download data. An exemplary embodiment of the processes to calculate CBIs (e.g., steps 1820-1822) are described in more detail below.

When the cache engine 230 is called, a cache benefit index (CBI) is calculated to determine if a downloaded application or data should be cached in the local file system 226. Generally, the CBI represents the total traffic volume saved in bytes between a remote server 102 or a gateway 108 and the mobile device 110 if an application or data is cached on the mobile device 110. Thus, the greater the CBI, the greater total traffic volume saved and the more benefit for caching an application or data. Calculating the CBI for each requested application or data ensures intelligent application/data caching on a mobile device 110, such that an optimal set of applications and data is cached in the limited local file system space to maximize traffic reduction between the mobile device 110 and the gateway 108 or the servers 102.

The CBI associated with each application or data is dynamically calculated. When an application or data is requested for download or update, the CBI associated with that application or data is calculated or recalculated, respectively. Typically, CBI calculation takes into account these parameters: the last application execution or data access time stamp, the application or data size, the frequency of execution or access, the frequency of update, an average update rate for the application or data, and/or other parameters.

After an application or data is downloaded from the gateway 108 or the server 102 and cached in the local file system 226, the volume of traffic between the gateway 108/server 102 and the mobile device 110 for purposes of downloading that application or data is zero; thus, caching an application or data in the local file system 226 reduces traffic. Once an application or data is cached, the volume of traffic between the gateway 108/server 102 and the mobile device 110 for purposes of updating that application or data increases; thus, the need to update a cached application or data in the local file system 226 increases traffic.

In an exemplary embodiment, “tₗ” is the last application execution or data access time stamp, “tₙ” is the current time stamp, and EFFECT_PERIOD is as defined in the configuration table (see FIG. 16). In one embodiment, any record in the application/data download tables (see FIGS. 8-9) or application/data storage tables (see FIGS. 10-11) whose last execution or access time stamp (tₗ) is less than or equal to tₙ−EFFECT_PERIOD and has a CBI equal to zero can be deleted from those corresponding tables.

For applications or data whose last execution or access are greater than tₙ−EFFECT_PERIOD, their CBIs are calculated each time a user request is received to execute or access the applications or data.

If an application or data is downloaded multiple times from the server 102 or the gateway 108 to the mobile device 110, the current download is equal to the last download plus one: nDownload_{new}=nDownload_{old}+1. Similarly, if a cached application or data receives multiple updates from the server 102 or the gateway 108, the current update is equal to the last update plus one: nUpdate_{new}=nUpdate_{old}+1. The new update rate, updateRate_{new}, is the average update rate before and after the current update. The rate_{new} is the current update traffic volume divided by the application or data size multiplied by 100. The updateRate_{new} can be calculated based on the old update rate and the rate_{new} in the following equation:

updateRate_{new}=(updateRate_{old}*nUpdate_{old}+rate_{new})/nUpdate_{new}.

Based on the discussion above, the CBI associated with an application or data can be calculated using the following equation: CBI=total download cost (TDC)−total update cost (TUC). For an application, TDC=nDownload×appSize and TUC=nUpdate×appSize×updateRate/100. For data, TDC=nDownload×dataSize and TUC=nUpdate×dataSize×updateRate/100. As shown, the greater the TDC, the more benefit for caching an application or data; the greater the TUC, the less benefit for caching an application or data.

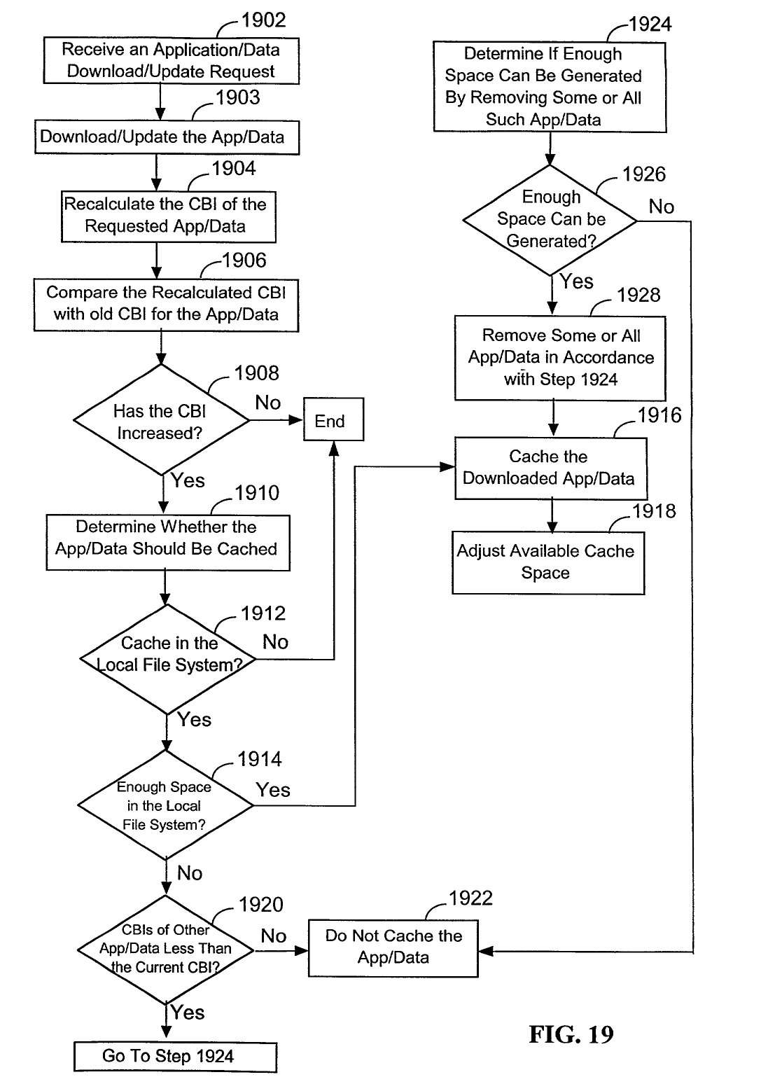

FIG. 19 illustrates an exemplary process in accordance with an embodiment of the invention. At step 1902, a request to download or update an application/data is received. The requested application/data is downloaded or updated (“the current application/data”) (step 1903). The CBI for the requested application/data is calculated or recalculated (step 1904). If there is enough free space in the local file system, the downloaded application/data is cached. If there is not enough free space in the local file system, the recalculated CBI is compared to an old CBI, if any, for the current application/data (step 1906). If the recalculated CBI is greater than the old CBI (step 1908), whether the application/data should be cached is determined (step 1910). If the recalculated CBI is less than or equal to the old CBI (step 1908), the process ends.

At step 1912, in an exemplary embodiment, the recalculated CBI is compared to CBIs of other applications/data stored in the local file system 226 to determine whether the current application/data should be cached. In another exemplary embodiment, the recalculated CBI is compared to a threshold, predetermined CBI value. In any event, if the recalculated CBI is greater than the other CBI(s), the current application/data should be cached. Next, whether there is enough space in the local file system for caching the application/data is determined (step 1914). If so, the current application/data is cached (step 1916). In an exemplary embodiment, if “FM_{c}” represents the free space in the local file system 226, “SZ_{ad}” represents the actual size of the current application/data, and “SZₘᵢ” represents the size of the current application/data's meta information, then if FM_{c}≧SZ_{ad}+SZₘᵢ, there is enough free space to cache the current application/data. The total available space in the local file system 226 is decreased by the size of the current application/data (step 1918). In an exemplary embodiment, the new total available space in the local file system is calculated as follows: FM_{cnew}=FM_{c}−(SZ_{ad}+SZₘᵢ).

Referring back to step 1914, if there is not enough space in the local file system 226, whether the CBI of any cached application/data is less than the recalculated CBI is determined (step 1920). If not, the current application/data should not be cached (step 1922). Otherwise, all of the cached application/data whose CBIs are less than the recalculated CBI are compared and some or all of those cached application/data are removed (step 1924). In an exemplary embodiment, assume there are “n” cached application/data that should be compared. The CBI of the i^{th} (1≦i≦n) application/data is represented as “CBI¹.” Similarly, the actual size of the i^{th} application/data is represented by “SZ_{ad}ⁱ” and the size of the i^{th} application/data's meta information is represented by “SZₘᵢ¹.” The following equations are solved:

$$Minimize {\sum }_{qi = 1}^{m} {CBI}^{qi}$$

$$Where {\sum }_{qi = 1}^{m} {CBI}^{qi} < {CBI}^{0} , \\ F {M}_{c} + \sum {( {SZ}_{ad}^{qi} + {SZ}_{mi}^{qi} )}^{3} {SZ}_{ad}^{0} + {SZ}_{mi}^{0}$$

where m≦n, 1≦qi≦n, CBI^{qi}, SZ_{ad}^{qi}, SZₘᵢ^{qi} represent the CBI, SZ_{ad}, SZₘᵢ of the qi^{th} application or data, respectively, and CBI⁰, SZ_{ad}⁰, SZₘᵢ⁰ represent the CBI, SZ_{ad}, SZₘᵢ of the current application or data, respectively. By solving the above equations, the smallest number of cached application/data with their respective CBIs less than the current CBI as necessary is removed from the local file system 226 to accommodate the caching of the current application/data.

Referring back to step 1924, if the removal of some or all of the cached application/data still does not generate enough space to cache the current application/data, it is not cached (step 1922). If the removal of some or all of the cached application/data does generate enough space to cache the current application/data, the some or all cached application/data are removed (step 1928). The current application/data is cached (step 1916) and the total available space in the local file system 226 is accordingly adjusted (step 1918). In an exemplary embodiment, the new total available space is calculated as follows:

$$F {M}_{cnew} = F {M}_{c} + {{\sum }^{m}}_{qi = 1} ( {SZ}_{ad}^{qi} + {SZ}_{mi}^{qi} ) - ( {SZ}_{ad}^{0} + {SZ}_{mi}^{0} )$$

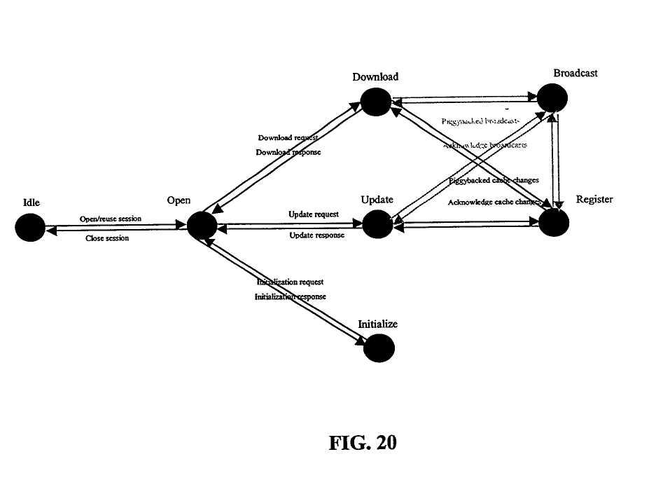

The smart connectivity protocol (SCP) is a protocol used for application/data management between the mobile device 110 and the gateway 108 or between the mobile device 110 and a remote server 102. FIG. 20 illustrates exemplary state machines of the SCP in accordance with an embodiment of the invention. Generally, when the SCP is in an Idle state, no communication session is created and, thus, no communication activity is taking place. When the SCP is in an Open state, a communication session is created; the system may be for communication requests from a client. When the SCP is in a Download state, a download request is sent or a download response is prepared. When the SCP is in an Update state, an update request is sent or an update response is prepared. When the SCP is in an Initialize state, an initialization request is sent or an initialization is prepared. When the SCP is in a Register state, cache changes are piggybacked or an acknowledgment is prepared. When the SCP is in a Broadcast state, broadcasts are piggybacked or an acknowledgment is prepared.

One advantage of the present invention is that applications and data cached on each mobile device 110 are customized in accordance with each user's operation history. That is, less frequently used applications and data cached on each mobile device 110 are continuously replaced (or swapped) by more frequently used applications and data based on each user's operation history. Thus, pre-loaded applications/data on a mobile device 110 can eventually be adapted to individual users.

The foregoing examples illustrate certain exemplary embodiments of the invention from which other embodiments, variations, and modifications will be apparent to those skilled in the art. The invention should therefore not be limited to the particular embodiments discussed above, but rather is defined by the claims.

What is claimed is:

1. A method for intelligently caching application or data on a mobile device, comprising the steps of:
receiving a request to execute or access a set of files, said set of files including an application or data;
downloading said set of files from a remote server or a gateway if said set of files is not pre-loaded or cached;
calculating a cache benefit index for said set of files;
determining available free space in a local file system;
caching said set of files in said local file system in accordance with said cache benefit index and available free space;
saving corresponding meta information in a database;
recording said request in said database; and
returning the location of said requested application in said local file system.

2. The method of claim 1, further comprising the step of:
searching a storage table in said database for a record that matches said set of files to determine whether said set of files is pre-loaded or cached.

3. The method of claim 1, wherein said downloading step further comprising the steps of:
opening a communication session with said remote server or said gateway;
sending a download request to said remote server or said gateway;
receiving a response, said response including said set of files; and
closing said communication session with said remote server or said gateway.

4. The method of claim 3, further comprising the steps of:
parsing said response to find a broadcast message;
accessing and updating a storage table in said mobile database in accordance with said broadcast message; and
sending a broadcast response to said remote server or said gateway.

5. The method of claim 4, wherein said accessing and updating steps includes the step of:
marking at least one set of files as out-of-date in accordance with said broadcast message.

6. The method of claim 1, wherein said step of determining available free space in a local file system includes the steps of:
comparing said cache benefit index to other cache benefit indices associated with already cached applications or data;
determining if enough space in said local file system can be generated by removing some or all of said already cached applications or data whose cache benefit indices are less than said cache benefit index; and
removing some or all of said already cached applications or data whose cache benefit indices are less than said cache benefit index if enough space in said local file system can be generated.

7. The method of claim 1, wherein said caching step includes the step of:
caching said set of files in said local file system if said cache benefit index is greater than a threshold value and said available free space indicates that there is enough space in said local file system to cache said set of files.

8. The method of claim 7, further comprising the step of:
calculating a current total available cache space after said set of files is cached into said local file system.

9. The method of claim 1, further comprising the step of:
initiating and maintaining sub-transactions during said downloading, said sub-transactions including application cache space management, data cache space management, and communication transactions.

10. A computer program product for intelligently caching application or data on a mobile device, comprising:
logic code for receiving a request to execute or access a set of files, said set of files including an application or data;
logic code for downloading said set of files from a remote server or a gateway if said set of files is not pre-loaded or cached;
logic code for calculating a cache benefit index for said set of files;
logic code for determining available free space in a local file system;
logic code for caching said set of files in said local file system in accordance with said cache benefit index and available free space;
logic code for saving corresponding meta information in a database;
logic code for recording said request in said database; and
logic code for returning the location of said requested application in said local file system.

11. The computer program product of claim 10, further comprising:
logic code for searching a storage table in said database for a record that matches said set of files to determine whether said set of files is pre-loaded or cached.

12. The computer program product of claim 10, wherein said logic code for downloading further comprising:
logic code for opening a communication session with said remote server or said gateway;
logic code for sending a download request to said remote server or said gateway;
logic code for receiving a response, said response including said set of files; and
logic code for closing said communication session with said remote server or said gateway.

13. The computer program product of claim 12, further comprising:
logic code for parsing said response to find a broadcast message;
logic code for accessing and updating a storage table in said mobile database in accordance with said broadcast message; and
logic code for sending a broadcast response to said remote server or said gateway.

14. The computer program product of claim 13, wherein said logic code for accessing and updating includes:
logic code for marking at least one set of files as out-of-date in accordance with said broadcast message.

15. The computer program product of claim 10, wherein said logic code for determining available free space in a local file system includes:
logic code for comparing said cache benefit index to other cache benefit indices associated with already cached applications or data;
logic code for determining if enough space in said local file system can be generated by removing some or all of said already cached applications or data whose cache benefit indices are less than said cache benefit index; and
logic code for removing some or all of said already cached applications or data whose cache benefit indices are less than said cache benefit index if enough space in said local file system can be generated.

16. The computer program product of claim 10, wherein said logic code for caching includes:
logic code for caching said set of files in said local file system if said cache benefit index is greater than a threshold value and said available free space indicates that there is enough space in said local file system to cache said set of files.

17. The computer program product of claim 16, further comprising:
logic code for calculating a current total available cache space after said set of files is cached into said local file system.

18. The computer program product of claim 10, further comprising:
logic code for initiating and maintaining sub-transactions during said downloading, said sub-transactions including application cache space management, data cache space management, and communication transactions.
